(19) United States
(12) Patent Application Publication
(10) Pub. No.: US 2020/0005353 A1
(43) Pub. Date: Jan. 2, 2020

(54) METHOD OF EVALUATING EFFECT OF ADVERTISEMENT, PROGRAM FOR PROCESSING INFORMATION, AND MOVING OBJECT

(71) Applicant: RENESAS ELECTRONICS CORPORATION, Tokyo (JP)

(72) Inventors: Tetsuya SHIBAYAMA, Tokyo (JP); Seiji MOCHIZUKI, Tokyo (JP); Nhat Van HUYNH, Tokyo (JP); Hiroshi UEDA, Tokyo (JP); Toshiyuki KAYA, Tokyo (JP)

(21) Appl. No.: 16/447,391

(22) Filed: Jun. 20, 2019

(30) Foreign Application Priority Data
Jun. 29, 2018 (JP) 2018-124625

(51) Int. Cl. G06Q 30/02

(52) U.S. Cl. CPC G06Q 30/0242; G06Q 30/0272

(57) ABSTRACT

The present invention provides a service car in which the effect of advertisement is increased and the convenience for users is increased.

The processing executed by the CPU of the moving object as the service car includes the steps of obtaining an advertisement from the server (S505), displaying the advertisement on a monitor outside the moving object (S510), accepting input of each signal output from an external information acquisition device (camera, microphone, sensor) provided in the moving object (S520), obtaining external information representing the periphery of the moving object and storing the information (S530), obtaining the travel information of the moving object (S540), estimating the effect of the advertisement based on the external information and the travel information (S550), determining a reward for the advertisement based on a predetermined reward criterion and the effect (S560), and calculating a usage fee for the moving object based on the determined reward.

### CROSS-REFERENCE TO RELATED APPLICATIONS

The disclosure of Japanese Patent Application No. 2018-124625 filed on. Jun. 29, 2018 including the specification, drawings and abstract is incorporated herein by reference in its entirety.

### BACKGROUND

The present disclosure relates to the provision of electronic advertisements, and more particularly, to techniques for providing electronic advertisements outside of a moving object.

Concerning a technology for displaying information on a train, which is an example of a moving object, for example, Japanese unexamined Patent Application publication No. 2008-85685 discloses a technology for “installing a small camera on an information display device in a train information display system, thereby analyzing when, where, who was interested in which information, and realizing an appropriate information display content instruction to the information display device”.

### SUMMARY

The technique disclosed in Japanese unexamined Patent Application publication No. 2008-85685 distributes advertisement content to passengers in a train, and the advertisement to be distributed is limited to passengers around an advertisement display device. Accordingly, there is a need in the art for a technique in which advertising is not limited to passengers.

In addition, although passengers can obtain information on the content of advertisements, the advertisement posting fee from the advertiser is paid to the railway management company and does not become a remuneration for passengers. Accordingly, there is a need for a technique in which advertising fees are rewarded for passengers.

The information from the camera also enables to know that he or she has watched the advertisement being delivered, but it is not possible to determine the actual advertising effect, i.e. whether it has been linked to the advertiser's revenue. Accordingly, there is a need for a technique that can determine the effectiveness of an advertisement.

For example, in the case of paying a remuneration to a passenger in the configuration disclosed in Japanese unexamined Patent Application publication No. 2008-85685, since a plurality of passengers can view the same advertisement, it is impossible to determine to which passenger the remuneration is paid, and it is very difficult to determine to which passenger the remuneration contributed to the revenue of the advertiser. Therefore, there is a need for a technique that can accurately determine the payee of a reward. There is also a need for a technique that can determine whether an advertisement has contributed to an advertiser's revenue.

The present disclosure has been made to solve the above-mentioned problems, and in one aspect, a technique for presenting an advertisement without being limited to passengers is disclosed. In another aspect, a technique is disclosed in which an advertisement posting fee becomes a reward for passengers. In another aspect, a technique that can determine advertising effectiveness is disclosed. In another aspect, a technique for accurately determining a payee of a reward is disclosed. In yet another aspect, a technique that can determine whether an advertisement has contributed to an advertiser's revenue is disclosed.

According to an embodiment, a computer-implemented method is provided. The method includes the steps of: acquiring an advertisement from a server via a network; displaying the advertisement outside the moving object (moving medium, moving apparatus); acquiring external information representing a periphery of the moving object based on a signal output from an external information acquisition device provided in the moving object; acquiring travel information of the moving object from the moving object; estimating an effect of the advertisement based on the external information and the travel information; and determining a reward for the advertisement based on a predetermined reward criterion and effect.

According to another embodiment, a program for controlling a moving object is provided. The program causes a moving object to execute the steps of: acquiring an advertisement from a server via a network; displaying the advertisement on the outside of the moving object; acquiring external information representing the periphery of the moving object based on a signal output from an external information acquisition device provided on the moving object; acquiring travel information of the moving object from the moving object; estimating an effect of the advertisement based on the external information and the travel information; and determining a reward for the advertisement based on a predetermined reward criterion and effect.

According to still another aspect, an information processing apparatus is provided. The information processing apparatus includes a display device provided outside the moving object, a sensor for acquiring external information representing the periphery of the moving object, and a processor connected to the display device and the sensor. The processor is configured to display an advertisement on the display device, to obtain travel information of the moving object from the moving object, to estimate an effect of the advertisement based on the external information and the travel information, and to determine a reward for the advertisement based on a predetermined reward criterion and effect.

In certain aspects, advertisements may be presented without the subject matter of the advertisement being limited to passengers. In other aspects, advertising fees may be a reward for passengers. In other aspects, advertising effectiveness can be determined. In other aspects, the payee of the remuneration may be accurately determined. In yet another aspect, it may be determined whether the advertisement contributed to the advertiser's revenue.

Other objects and novel features will become apparent from the description of this specification and the accompanying drawings.

### BRIEF DESCRIPTION OF THE DRAWINGS

FIG. 1 schematically illustrates a configuration of a system for displaying advertisements using a moving object 100 according to an aspect.

FIG. 2 is a block diagram showing a hardware configuration of a computer apparatus 200.

FIG. 3 is a block diagram illustrating a hardware configuration of a computer 110.

FIG. 4 is a conceptual representation of one embodiment of data storage on the hard disk 5 of the server 170.

FIG. 5 is a diagram conceptually illustrating an aspect of storage of data in a flash memory 305 of the computer 110.

FIG. 6 is a flowchart illustrating a portion of the processing performed by the computer 110 possessed by the moving object 100.

FIG. 7 is a block diagram illustrating an outline of the configuration of the system. 60 according to the present embodiment.

FIG. 8 is a block diagram illustrating a hardware configuration of a smartphone 600.

FIG. 9 is a diagram schematically illustrating a configuration of data 800 according to an embodiment.

FIG. 10 is a conceptual representation of one embodiment of the storage of data on the hard disk 5 of the server 170.

FIG. 11 is a diagram showing the relationship between time and reward (evaluation points).

FIG. 12 is a diagram illustrating an outline of a configuration of a system according to a third embodiment.

FIG. 13 is a block diagram illustrating a configuration of a system according to a fourth embodiment.

FIG. 14 is a diagram illustrating a schematic view of a system according to a fifth embodiment.

FIG. 15 is a schematic diagram illustrating a configuration of a system according to a sixth embodiment.

### DETAILED DESCRIPTION

Embodiments will be described below with reference to the drawings. In the following description, the same components are denoted by the same reference numerals. Their names and functions are also the same. Therefore, detailed description thereof will not be repeated.

First, the technical idea according to the present disclosure will be described. Automatic driving of vehicles is expected to become widespread in the future. When automatic driving is widespread, there is a possibility that a mode of owning and using an automobile (so-called owner car) and a mode of using without owning an automobile (so-called service car) become bipolar. On the other hand, a technique in which advertisements are displayed on a vehicle body of a transportation device such as a bus or a railway, and the advertisements are provided while the vehicle is traveling has also become widespread. When service cars become popular, advertisements may be displayed outside the car. Hereinafter, the technical idea according to the present disclosure will be described using a transport device including a service car as a moving object (moving medium, moving apparatus).

### First Embodiment

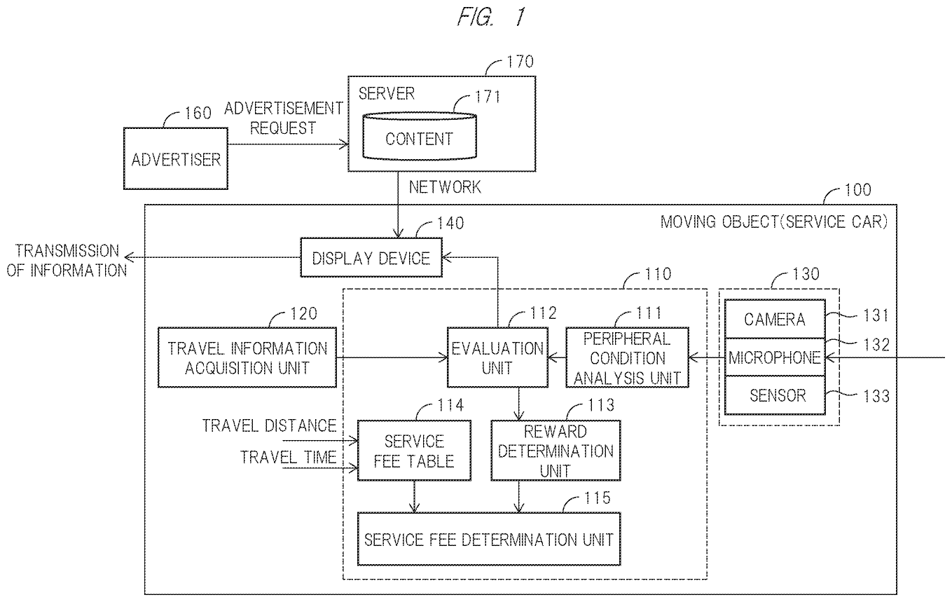

An outline of a system according to the present embodiment will be described with reference to FIG. 1. FIG. 1 schematically illustrates a configuration of a system for displaying advertisements using a moving object 100 according to an aspect. In one aspect, the moving object 100 is an automobile, bus, truck, or other transport device used in the transportation of people or goods. Hereinafter, the moving object 100 may be referred to as a service car. Automobiles are used in car sharing, rental cars, automatic driving services, and the like. Buses are used in services that transport passengers at cost, such as route buses or lease buses, or in services that transport passengers free of charge at airports or other private roads. Tracks are used in transportation services, such as courier delivery.

Advertising content produced by an advertiser or agency is stored on a server 170 external to the moving object 100. The moving object 100 downloads the content 171 from the server 170 through the network, and reproduces (displays or outputs sounds) the content 171 to the outside of the moving object 100 by the display device 140 installed in the moving object 100. In addition, the moving object 100 collects external information from a camera 131, a microphone 132, a sensor 133, and the like, and analyzes whether or not surrounding people are interested in the advertisement. The moving object 100 performs evaluation by inputting the analysis result and the traveling information such as the position information, the traveling distance, and the traveling speed transmitted from the apparatus inside the moving object 100, and calculates an evaluation value indicating the evaluation result. If the evaluation value exceeds a preset threshold value, the moving object 100 determines as highly evaluated, and a reward is added to the account of the user of the moving object 100. The obtained reward is reduced from the service fee at the time of settlement of the fee for use of the moving object 100, thereby being returned to the user.

The moving object 100 includes a computer 110, a travel information acquisition unit 120, an external information acquisition unit 130, and a display device 140. The computer 110 includes a peripheral situation analysis unit 111, an evaluation unit 112, a reward determination unit 113, a service fee table 114, and a service fee determination unit 115. The external information acquisition unit 130 may include at least one of a camera 131, a microphone 132, and a sensor 133. The peripheral situation analysis unit 111, the evaluation unit 112, the reward determination unit 113, and the service fee determination unit 115 may be realized by a CPU or other general-purpose processor in one aspect, and may be realized by special-purpose hardware or an accelerator in another aspect.

The moving object 100 can be connected to the server 170 by wireless or wireline. The server 170 is implemented by a computer having a well-known configuration. The server 170 holds advertisements and other content data. The content data is, in some aspects, provided by an advertiser 160.

The travel information acquisition unit 120 acquires information indicating a state of the moving object 100 during travel. The information may include position information, speed, departure point, destination, travel route, scheduled arrival time, etc. of the moving object 100.

The external information acquisition unit 130 acquires information external to the moving object 100, and transmits the acquired information to the computer 110. More specifically, the camera 131 is provided outside the moving object 100. For example, one or more cameras 131 may be positioned in front of, on the right side, on the left side, on the back of the moving object 100. Each camera 131 photographs the surroundings of the moving object 100, and image data obtained by the photographing is sent to the computer 110. The microphone 132 is also provided outside the moving object 100. The microphone 132 may be arranged in the same manner as the camera 131. The sound signal collected by the microphone 132 is also sent to the computer 110. The sensor 133 includes, for example, a proximity sensor. In one aspect, a plurality of proximity sensors are disposed on a side of the moving object 100 to detect the proximity of an object to the moving object 100. The output from the proximity sensor is also transmitted to the computer 110. In addition, in some aspects, the distance sensor (not shown) can acquire distance information, and the LiDAR and radar (not shown) can grasp the surrounding state, or a combination thereof can grasp the surrounding state with high accuracy.

Based on the information acquired by the travel information acquisition unit 120 and the information acquired by the external information acquisition unit 130, the computer 110 calculates a fee (service fee) to be charged to the user of the moving object 100.

More specifically, the peripheral condition analysis unit 111 analyzes the peripheral condition of the moving object 100. For example, the surrounding situation analysis unit 111 estimates the approximate position of an object in the surrounding area (e.g., a person who comes close to see an advertisement) using the information from the sensor 133, and analyzes the image data from the camera 131 based on the estimated position. The peripheral situation analysis unit 111 performs face extraction processing from the image data to determine whether or not the object is a person. Further, when judging that the object is a person, the peripheral situation analysis unit 111 estimates the gender, age group, gaze information (information indicating whether or not the advertisement is noticed from the direction in which the object is facing) and the like of the person, and acquires the estimation result as detailed data. In another aspect, the peripheral situation analysis unit 111 extracts keywords from conversations of pedestrians around the moving object 100 using sound data from the microphone 132. The distance from the moving object 100 to the object (person), gender, age group, gaze information, and conversation keywords obtained by the analysis by the peripheral situation analysis unit 111 are input to the evaluation unit 112.

The evaluation unit 112 evaluates how effectively the advertisement displayed on the moving object 100 functions based on the peripheral information input from the peripheral situation analysis unit 111 and the travel information input from the travel information acquisition unit 120. For example, the evaluation unit 112 evaluates the effect of the advertisement by classifying the advertisement into a plurality of stages such that the effect of the advertisement by the current advertisement is (1) smaller than the standard, (2) standard, and (3) larger than the standard. During the traveling of the moving object 100, since the surrounding conditions change every moment, the evaluation conditions also change in accordance with the conditions. Therefore, the evaluation unit 112 evaluates the effect of the advertisement in consideration of the travel information. The result of the evaluation is input to the reward determination unit 113.

As an advertisement evaluation method, the evaluation unit 112 estimates the degree of effect of the advertisement based on, for example, the number of people watching the advertisement (gaze points). In another aspect, the evaluation unit 112 may further estimate, as the effect of the advertisement, the number of people watching the advertisement relative to the total number of people including those not watching the advertisement.

In another aspect, when a gender, age group, or other attribute is added to each content of each advertisement, the evaluation unit 112 may add the extraction result to a numerical value representing the effect of the advertisement in accordance with the attribute extracted by the peripheral situation analysis unit 111.

If the number of persons detected when the moving object 100 is stopped on the street is the same as the number of persons detected when the moving object 100 is running, then it can be presumed that the advertisements presented to the moving object 100 will also attract public attention while traveling. Therefore, when the number of persons detected at the time of stopping the moving object 100 is the same as the number of persons detected at the time of running, the evaluation unit 112 may determine that the effect of the advertisement is (3) larger than the standard on the assumption that the advertisement is attracting attention.

In another aspect, the number of persons detected when the moving object 100 is stopped on the road may be less than a predetermined reference value. In this case, the evaluation unit 112 may determine that the effect of the advertisement is (1) smaller than the standard because it is difficult to attract the attention of the passer even in a visible situation.

Alternatively, in yet another aspect, the number of persons detected while the moving object 100 is traveling may be less than the number of persons detected when the moving object 100 is stopped on the road. In this case, the evaluation unit 112 can determine that the effect of the advertisement is (2) standard in that it becomes difficult to attract attention according to the travel of the moving object 100.

As another example, the evaluation unit 112 may evaluate the effectiveness of the advertisement based on the number of viewers and gender. For example, a case where seven women and three men are detected around the moving object 100 will be described. When it is determined that three women and one man are watching the advertisement and the distance between the other four women and the moving object 100 is long, when the target of the advertisement is “female”, the evaluation unit 112 may determine the effect of the advertisement according to the range of evaluation points as follows.

(Evaluation Criteria) a) Evaluation Point<5.0: Effectiveness is less than standard b) 5.0≤Evaluation Point<8.0: Effectiveness (Effectiveness is standard) c) 8≤Evaluation Point: Effectiveness is greater than standard. Since a total of four people are watching advertisements, in the above case where the Evaluation Point of the Standard (Gaze Point) is set to “1” in advance, the gaze point for that case is calculated as follows.

Gaze Point=4×1=4 (points). Because it is the person in the vicinity of the moving object 100 who can actually see the advertisement, the effect of the advertisement on the person (four women) who is away from the moving object 100 is excluded from consideration. In this case, when the standard headcount point of is set to “0.1” in advance, the evaluation point (headcount point) is calculated as follows.

Headcount Point=(10−4)×0.1=0.6 (points). When the target of the advertisement is “Women”, 7 women were detected in the vicinity of the moving object 100, and if the standard evaluation point (target point) is set to “0.1” in advance, the target point is calculated as follows.

Target Point=7×0.1=0.7 (point). Because the total of the evaluation points becomes 4+0.6+0.7=5.3, the evaluation unit 112 can determine that the advertisement is effective. The determination result is input to the reward determination unit 113.

The reward determination unit 113 determines a reward for the advertisement based on the result of the evaluation unit 112. For example, the reward determination unit 113 determines the reward by integrating the input current evaluation results. Therefore, if the desired evaluation by the evaluation unit 112 continues for a long time, for example, if the evaluation that an advertisement is effective (the effect is standard) or the evaluation that the effect of the advertisement is “larger than standard” continues for a long time, the reward determination unit 113 determines that the displayed advertisement is effectively functioning and generates more reward. The determined reward may be used to reduce the usage fee of the moving object 100.

The service fee table 114 defines a service fee (usage fee of the moving object 100) which is defined in advance in accordance with the travel distance, the travel time, the service time zone, and the day of the week.

The service fee determination unit 115 calculates a fee to be charged to the user of the moving object 100 based on the fee determined by the reward determination unit 113 and the service fee. The determined fee may be notified to the user's account or by the display device 140.

Although FIG. 1 shows a case where the computer 110 is mounted on the moving object 100, the above-described processing executed by the computer 110 may be executed outside the moving object 100. For example, these processes may be executed as cloud computing by an external computer such as the server 170. In yet another aspect, these processes may be distributed by multiple computers.

### Hardware Configuration of Computer

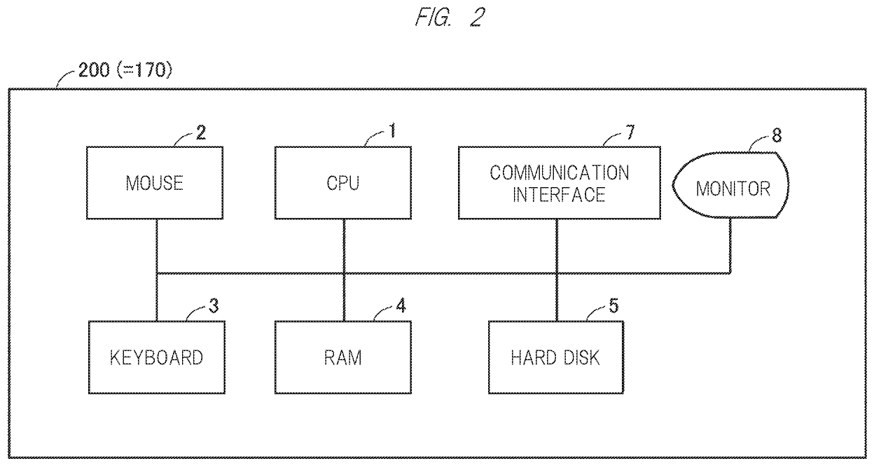

The hardware configuration of the server 170 used in the present embodiment will be described with reference to FIG. 2. FIG. 2 is a block diagram showing a hardware configuration of the computer apparatus 200 functioning as the server 170.

The computer apparatus 200 includes, as main components, a CPU (Central Processing Unit) 1 for executing a program, a mouse 2 and a keyboard 3 for receiving instructions from a user of the computer apparatus 200, a RAM (Random. Access Memory) 4 for storing volatile data generated by executing the program by a CPU1 or data input via the mouse 2 or the keyboard 3, a hard disk 5 for storing involatile data, a communication interface 7, and a monitor 8. The constituent elements are connected to each other by a bus. The communication interface 7 includes, but is not limited to, a USB (Universal Serial Bus) interface, a wired LAN (Local Area Network), a wireless LAN, a Bluetooth (registered trademark) interface, and the like.

The processes in the computer 200 are realized by the respective hardware and software executed by the CPU 1. Such software may be stored in advance in the hard disk 5. Software may also be stored in a CD-ROM or other computer readable non-volatile data recording medium and distributed as a program product. Alternatively, the software may be provided as a program product that can be downloaded by an information provider connected to the Internet or other network. Such software is read from a data recording medium by an optical disk drive or other data reading device, or is downloaded via the communication interface 7, and then temporarily stored in the hard disk 5. The software is read from the hard disk 5 by the CPU 1, and the software is stored in the RAM 4 in the form of executable programs. The CPU 1 executes the programs.

Each element of the computer apparatus 200 shown in FIG. 2 is a general one. Therefore, it can be said that the most essential part according to the present embodiment is the program stored in the computer apparatus 200. Since the operation of each hardware of the computer apparatus 200 is well known, the detailed description thereof will not be repeated.

Note that the data recording medium is not limited to a CD-ROM, an FD (Flexible Disk), and a hard disk, and may be a non-volatile data recording medium that fixedly carries programs, such as a magnetic tape, a cassette tape, an optical disk (MO (Magnetic Optical Disc)/MD (Mini Disc)/DVD (Digital Versatile Disc)), an IC (Integrated Circuit) card (including a memory card), an optical card, a mask ROM, a EPROM (Electronically Programmable Read-Only Memory), a EEPROM (Electronically Erasable Programmable Read-Only Memory, or a semiconductor memory such as a flash ROM.

The program referred to herein may include a program in the form of a source program, a compressed program, an encrypted program, and the like, as well as a program directly executable by a CPU 1.

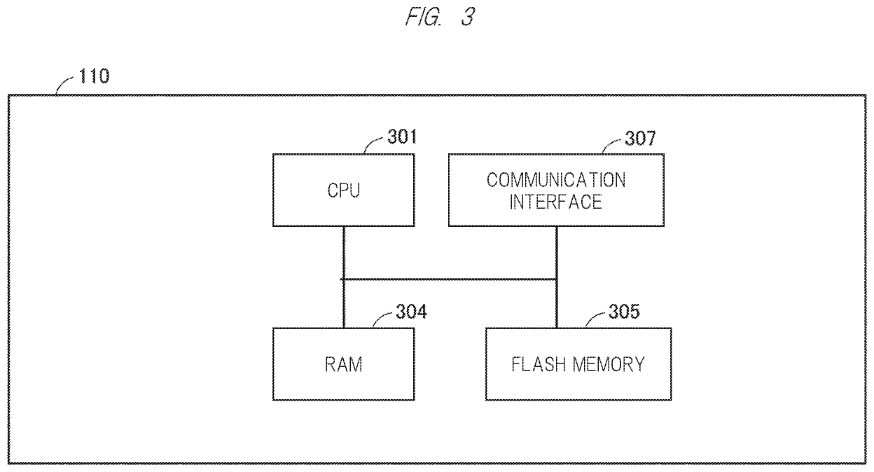

The hardware configuration of the computer 110 used in the present embodiment will be described with reference to FIG. 3. FIG. 3 is a block diagram showing a hardware configuration of the computer 110. In one aspect, the computer 110 is implemented in System on Chip.

The computer 110 includes, as main components, a CPU 301 for executing a program, a RAM 304 for volatile storage of data generated or inputted by executing the program by a CPU 301, a flash memory 305 for non-volatile storage of data, and a communication interface 307. The constituent elements are connected to each other by a bus.

### Data Structure

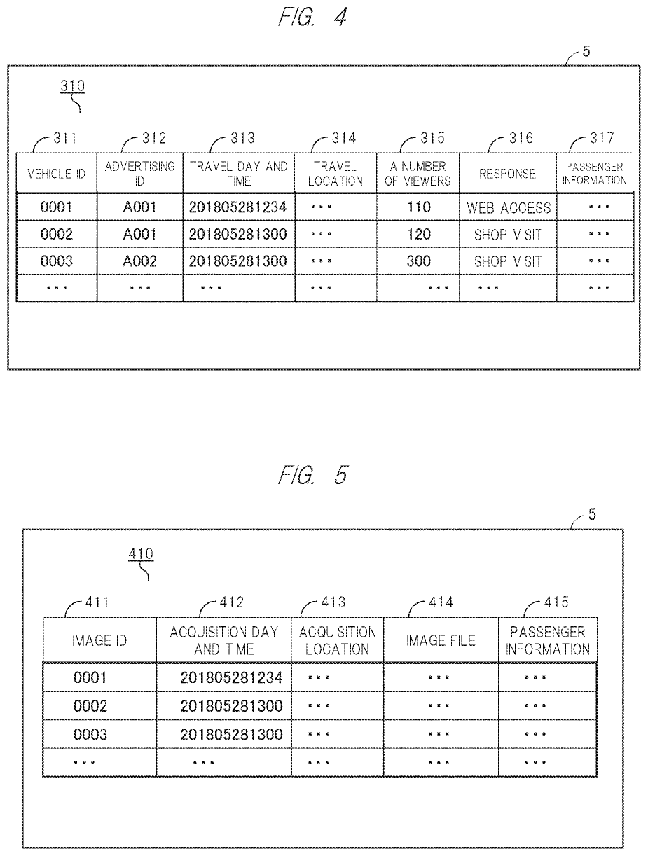

The data structure of the server 170 will be described with reference to FIG. 4. FIG. 4 is a diagram conceptually showing one mode of storage of data in the hard disk 5 of the server 170. The hard disk 5 holds a table 310. The table 310 stores data relating to advertisements to be delivered to each moving object 100.

More specifically, the table 310 includes a vehicular ID 311, an advertising ID 312, a travel date and time 313, a travel location 314, a number of viewers 315, a response 316, and passenger information 317. The vehicular ID 311 identifies the respective moving media 100. The advertisement ID 312 identifies an advertisement to be displayed externally by the moving object 100 having the vehicle ID. The type and number of advertisements displayed on the outside by the moving object 100 are not limited to one. Multiple advertisements may be displayed on a single moving object 100. The traveling date and time represents the date and time when the moving object 100 traveled. The travel location 214 represents the path traveled by the moving object 100. The route is shown as, for example, a set of position information acquired at predetermined time intervals. The number of viewers 315 represents the number of viewers detected as the viewer who was viewing the advertisement. In one aspect, the number of viewers 315 is transmitted from the moving object 100. The response 316 represents the presence or absence of a response to the advertisement and the content of the response. Examples of the content of the response include a shop visit, a telephone call, a Web access, a Web reservation, and the like. For example, a passerby who sees an advertisement displayed outside the moving object 100 may photograph the QR (Quick Response) code (registered trademark) of the advertisement on a smartphone and confirm the detail of the advertisement on the Web. When such access is detected, the server 170 updates the data of the response 316, depending on the content of the access. The passenger information 317 is information of a passenger of the moving object 100. The passenger information includes, for example, a passenger name, a passenger ID, a reserved date and time of boarding, a date and time of actually boarding, and the like.

The data structure of the computer 110 will be described with reference to FIG. 5. FIG. 5 is a diagram conceptually showing one mode of storage of data in the flash memory 305 of the computer 110. The flash memory 305 holds a table 410. The table 410 includes image ID 411, acquisition date and time 412, acquisition location 413, image file 414, and passenger information 415. The image ID 411 specifies an image captured by the cameras 131. The image ID 411 is automatically named by, for example, a time stamp including a date and time at which the image capturing is started. The acquisition date and time 412 specifies the date and time at which the image was acquired. The acquisition location 413 specifies the location where the image was acquired. The location is acquired by, for example, a positioning function (e.g., a GPS (Global Positioning System) function) included in the moving object 100. The image file 414 are image data conforming to, for example, the MPEG (Moving Picture Experts Group) format or another standard, but the standard is not particularly limited. The passenger information 415 is information of a passenger of the moving object 100. The passenger information includes, for example, a passenger name, a passenger ID, a reserved date and time of boarding, a date and time of actually boarding, and the like. In some aspects, passenger information 415 is transmitted from server 170.

### Control Structure

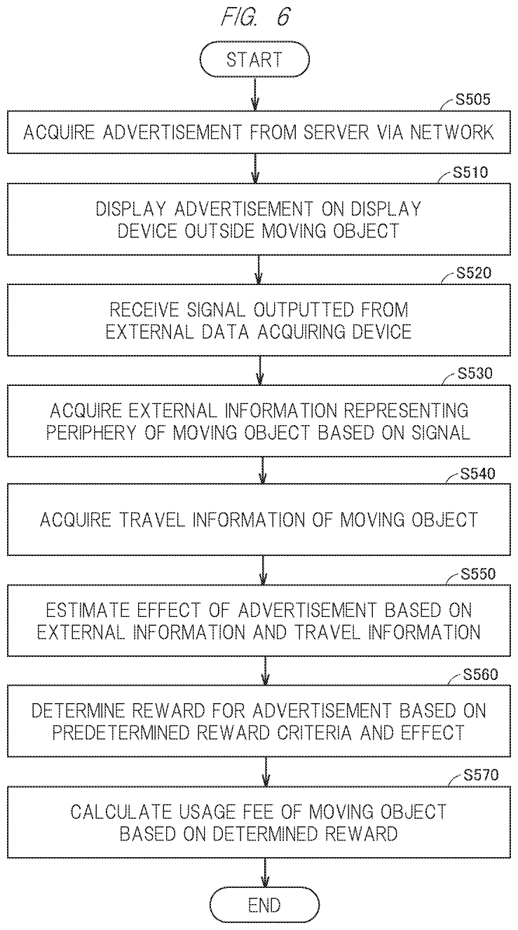

The control structure of the moving object 100 will be described with reference to FIG. 6. FIG. 6 is a flowchart showing a part of processing executed by the computer 110 included in the moving object 100.

In operation 5505, the CPU 301 acquires advertisements from the servers 170 via the networks.

At 5510, the CPU 301 displays the advertisements on the display device 140 of the moving object 100.

In 5520, the CPU 301 receives signals outputted from the external data acquiring device provided in the moving object 100. For example, the CPU 301 receives inputs of signals outputted from the camera 131, the microphone 132, and the sensor 133.

In 5530, the CPU 301 acquires external information representing the periphery of the moving object based on the signals, and stores the information. The information may include the presence or absence of an object approaching the moving object 100, the number of persons presumed to be viewing the moving object 100, whether male or female, the distance between the moving object 100 and the person, etc.

In 5540, the CPU 301 acquires travel data of the moving object 100. For example, the CPU 301 acquires the traveling velocity, the traveling position, and the like of the moving object 100.

At 5550, the CPU 301 estimates the effects of the advertisements based on the external information and the travel information. For example, as the evaluating unit 112, the CPU 301 determines whether the effectiveness of the advertisement is standard, smaller than the standard, or larger than the standard based on the result of the analysis by the surrounding situation analyzing unit 111 and the travel information acquired by the travel information acquisition unit 120.

In operation 5560, the CPU 301, as the reward determination unit 113, determines a reward for the advertisements based on predetermined reward criteria and effects.

In 5570, the CPU 301 calculates the usage fee of the moving object based on the determined reward. For example, the CPU 301, as the service fee determination unit 115, calculates a service usage fee to be imposed on a user of the moving object 100 (e.g., a user of the car sharing service) based on the service fee table 114 and the result of determination by the fee determination unit 113. Thereafter, the CPU 301 notifies the user of the calculated usage fee or displays it on a passenger monitor (not shown) provided inside the moving object 100.

As described above, according to the present embodiment, whether or not the advertisement is effectively acting is determined from the external information obtained from the camera 131, the microphone 132, the sensor 133, and the like, and the travel information held by the moving object 100, the effect of the advertisement is evaluated, the reward for the user of the moving object 100 is determined, and the amount may be reduced from the standard fee.

According to such a configuration, (1) since it is possible to return the advertisement posting fee paid by the advertiser to the user of the service (passenger of the moving object 100), the usage fee is substantially reduced, and convenience for the user is improved. (2) Since the advertiser can quantitatively determine whether or not the requested advertisement is effective, the convenience for the advertiser can be improved. (3) Since the service can be provided at a substantially low fee, an increase in the number of users is expected. Additionally, since the user can be enclosed, a business advantage can be increased for the operation manager of the moving object 100 (e.g., the operator of the service car business, etc.).

### Second Embodiment

The second embodiment will now be described. According to the present embodiment, it is possible to evaluate an advertisement based on access to detailed data of the advertisement by a passer or the like who has seen the advertisement, which is different from the above-described embodiment. In other words, it may be necessary to make the evaluation method more certainly effective for advertising a high evaluation. Therefore, when a person who watches an advertisement intends to purchase a service or a product advertised by the advertisement or actively obtain information, it is desirable that the effect of the advertisement is large (high evaluation).

The passer or the like may access detailed information of the advertisement from a terminal such as a smart phone by using information transmitted simultaneously with the advertisement (e.g., QR Code (registered trademark)). In this case, the access history to the detailed information of the advertisement is transmitted to the moving object 100 through the network, and the evaluation unit 112 may determine that the advertisement has been highly evaluated. The information originating from the moving object 100 along with the advertisement may include, for example, a vehicle number displayed on the electronic medium for the viewer to understand, a QR coded dedicated address, etc. In another aspect, the evaluation unit 112 may retrieve the moving object 100 traveling near the smartphone from the position information transmitted from the smartphone and notify the retrieved moving object 100 of the information indicating that the information has been accessed by the user.

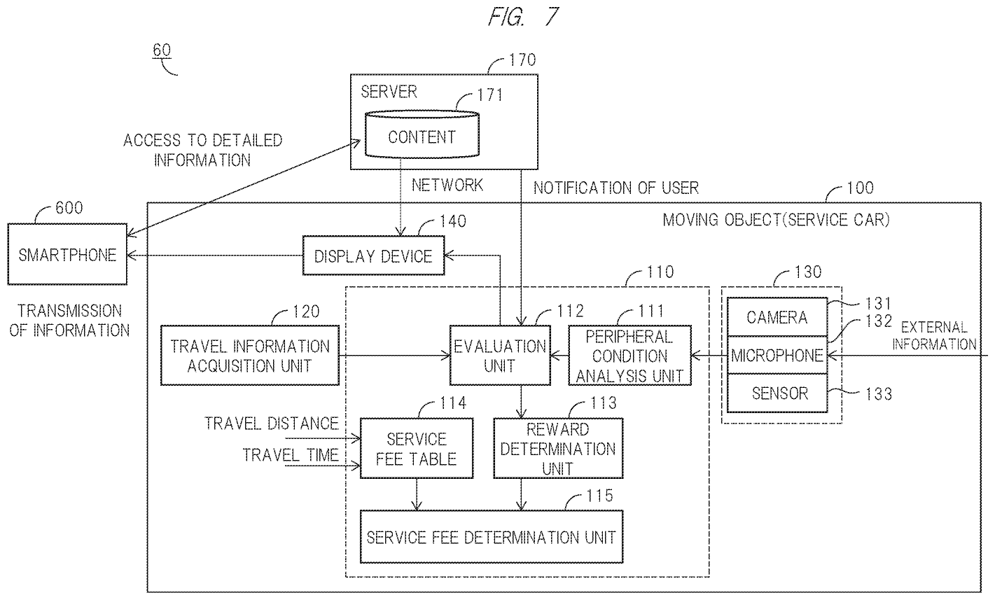

Referring to FIG. 7, a system 60 according to the present embodiment will be described. FIG. 7 is a block diagram showing an outline of the configuration of the system 60 according to the present embodiment. Components that are the same as those included in the above-described embodiment are denoted by the same reference numbers. Their functions are also the same. Therefore, the same description will not be repeated.

In addition to the configuration shown in FIG. 1, the system 60 includes a smartphone 600. The smartphone 600 is used by a passer, pedestrian, or other person outside the moving object 100. The smartphone 600 can access the server 170 via the Internet or other communication lines. Upon access, the smartphone 600 transmits viewing information to the server 170. The viewing information includes identification information, location information, and user information of the smartphone 600, identification information of an advertisement displayed on the moving object 100, and the like. The server 170 may transmit information to the moving object 100 via the Internet or other communication lines. The transmitted information may include viewing information transmitted by the smartphone 600, such as identification information of a user who has accessed detailed information of an advertisement displayed by the moving object 100, identification information of the advertisement, etc.

The evaluation unit 112 evaluates the effect of the advertisement based on the analysis result by the peripheral situation analysis unit 111, the information acquired by the travel information acquisition unit 120, and the information sent from the server 170. For example, if the number of accesses to detailed information of an advertisement is larger than that of other advertisements, it is estimated that the effect of the advertisement is larger than the standard effect. Therefore, in one aspect, the evaluation unit 112 may add the evaluation points of the number of accesses in the calculation formula of the evaluation points described above.

### Configuration of Smartphone

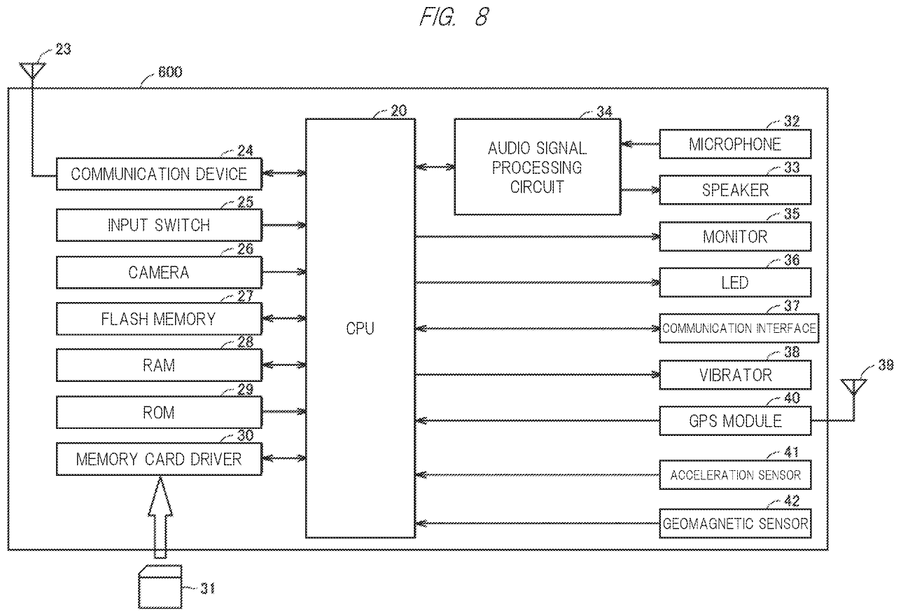

The configuration of the smartphone 600 will be described with reference to FIG. 8. FIG. 8 is a block diagram showing a hardware configuration of the smartphone 600.

The smartphone 600 includes a CPU 20, an antenna 23, a communication device 24, an input switch 25, a camera 26, a flash memory 27, a RAM 28, a ROM 29, a memory card driver 30, a microphone 32, a speaker 33, an audio signal processing circuit 34, a monitor 35, an LED (Light Emitting Diode) 36, a communication interface 37, a vibrator 38, a GPS antenna 39, a GPS module 40, an acceleration sensor 41, and a geomagnetic sensor 42. A memory card 31 may be mounted on the memory card drive device 30.

The antenna 23 receives a signal transmitted by a base station or transmits a signal for communicating with another communication device via the base station. The signals received by the antennas 23 are subjected to front-end processing by the communication device 24, and the processed signals are sent to the CPU 20.

The CPU 20 performs a process for controlling the operation of the smartphone 600 based on instructions provided to the smartphone 600. When the smartphone 600 receives the signal, the CPU 20 performs a predetermined process on the basis of the signal sent from the communication device 24, and sends the processed signal to the audio signal processing circuitry 34. The audio signal processing circuit 34 performs predefined signal processing on the signal, and sends the processed signal to the speaker 33. The speaker 33 outputs sound based on the signal.

The input switch 25 receives an instruction input to the smartphone 600. The input switch 25 is realized by a touch sensor, a button provided on the chassis of the smartphone 600, or the like. Signals corresponding to the input instructions are input to the CPU 20.

The microphone 32 receives an utterance from the smartphone 600, and transmits a signal corresponding to the uttered voice to the voice signal processing circuit 34. The audio signal processing circuit 34 performs predetermined processing for a call based on the signal, and transmits the processed signal to the CPU 20. The CPU 20 converts the signals into data for transmission, and transmits the converted data to the communication device 24. The communication device 24 generates a signal for transmission by using the data, and transmits the signal to the antenna 23.

The flash memory 27 stores data sent from the CPU 20. The CPU reads data stored in the flash memory 27, and executes a predetermined process by using the data.

The RAM 28 temporarily holds data generated by the CPU 20 based on operations performed on the input switches 25. The ROM 29 stores programs or data for causing the smartphone 600 to execute predetermined operations. The CPU 20 reads the programs or data from the ROM 29 and controls the operation of the smartphone 600.

The memory card driving device 30 reads data stored in the memory card 31 and sends the data to the CPU 20. The memory card driving device 30 writes the data outputted by the CPU 20 into the storage area of the memory card 31.

The voice signal processing circuit 34 performs the signal processing for the call as described above. In the embodiment shown in FIG. 8, the CPU 20 and the audio signal processing circuit 34 are shown as separate structures, but in other aspects, the CPU 20 and the audio signal processing circuit 34 may be integrally formed.

The monitor 35 is a touch operation type monitor, but a mechanism for accepting a touch operation is not particularly limited. The monitor 35 displays images defined by the data based on the data acquired from the CPU 20. For example, a still image, a moving image, a map, or the like stored in the flash memory 27 is displayed.

The LED 36 emits light based on signals outputted from the CPU 20. In one aspect, the communication interface 37 is implemented by WiFi (Wireless Fidelity), a Bluetooth (registered trademark), NFC (Near Field Communication), or the like. In another aspect, the communication interface 37 accepts attachment of a cable for data communication. The communication interface 37 transmits signals outputted from the CPU 20. Alternatively, the communication interface 37 transmits data included in signals received from the outside of the smartphone 600 to the CPU 20.

The vibrator 38 performs oscillation at predetermined frequencies based on signals outputted from the CPU 20.

The GPS antenna 39 receives GPS signals transmitted from four or more satellites. Each received GPS signal is input to the GPS module 40. The GPS module 40 performs positioning processing using each GPS signal and a known technique, and acquires position information of the smartphone 600.

The acceleration sensor 41 detects acceleration acted on the smartphone 600. In one aspect, the acceleration sensor 41 is implemented as a three-axis acceleration sensor. The detected accelerations are inputted to the CPU 20. The CPU20 detects the movement and the attitude (inclination) of the smartphone 600 based on the accelerations.

The geomagnetic sensor 42 detects the direction in which the smartphone 600 faces. The information acquired by the detection is inputted to the CPU 20.

### Data Structure

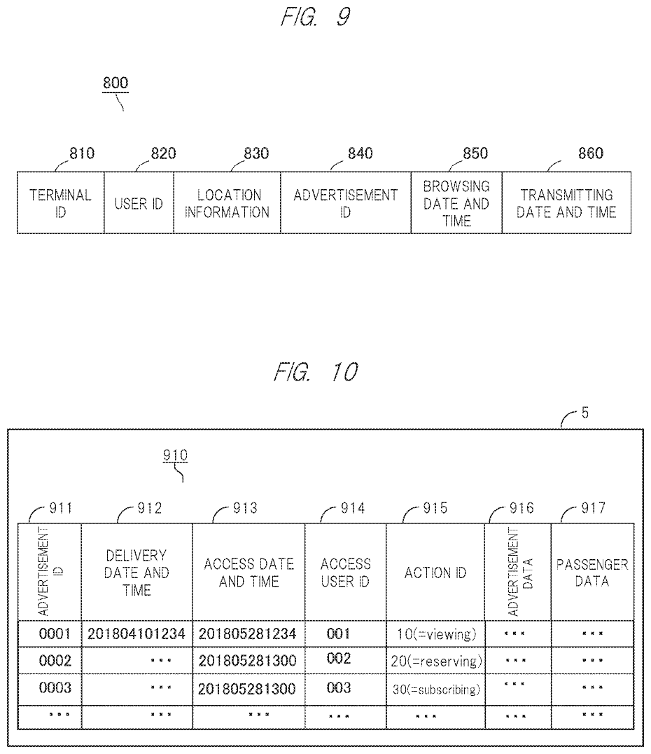

Referring to FIG. 9, data 800 transmitted from the smartphone 600 to the server 170 will be described. FIG. 9 is a diagram schematically illustrating a configuration of data 800 according to an embodiment. The data 800 includes a terminal ID 810, a user ID 820, location information 830, an advertisement ID 840, a browsing date and time 850, and a transmitting date and time 860.

The terminal ID 810 identifies the smartphone 600. The user ID 820 identifies the user of the smartphone 600. The location information 830 identifies the location where the data 800 was generated. For example, the position information 830 includes the position at which the user shoots the QR code with the camera of the smartphone 600 with facing the moving object 100. The advertisement ID 840 identifies the advertisement. The browsing date and time 850 identifies the date and time at which the data 800 was generated, i.e., the date and time at which access to the advertisement was made. The transmission date and time 860 identifies the date and time at which the data 800 was transmitted to the server 170. In some aspects, the browsing date and time 850 and the transmission date and time 860 may be different dates. For example, even if access to the detailed information is not performed at the time when the user photographs the advertisement, the browsing date and time 850 and the transmission date and time 860 may be different dates when the access is performed later.

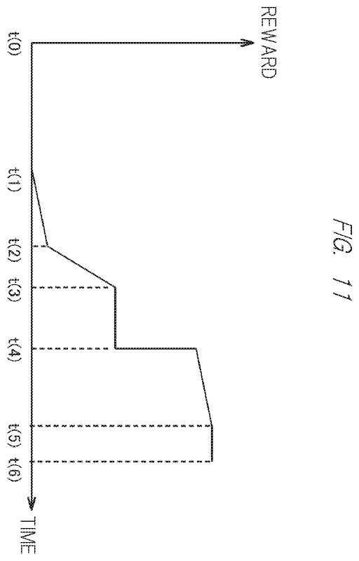

Next, the data structure of the server 170 will be described with reference to FIG. 10. FIG. 10 is a diagram conceptually showing one mode of storage of data in the hard disk 5 of the server 170. The hard disk 5 holds a table 910. The table 910 includes an advertisement ID 911, a delivery date and time 912, an access date and time 913, an access user ID 914, an action ID 915, advertisement data 916, and passenger data 917. The advertisement ID 911 identifies the advertisement to be delivered. The delivery date and time 912 represents the date and time when the advertisement was delivered. The access date and time 913 represents the date and time when access to the detailed information of the advertisement was made. The access user ID 914 identifies the user who has accessed the detail. The action ID 915 identifies the action of the user specifically performed in the access. The operations may include viewing detailed information, reserving goods or services advertised by the advertisement, subscribing to the goods or services, etc. The advertisement data 916 is transmitted to the moving object 100 via the network. The passenger information 917 is information of a passenger of the moving object 100. The passenger information includes, for example, a passenger name, a passenger ID, a reserved date and time of boarding, a date and time of actually boarding, and the like. In one aspect, passenger information 917 is generated based on data transmitted from a communication terminal used by a user who is attempting to utilize moving object 100 on making a reservation. In another aspect, the server 170 may receive passenger information 917 from the moving object 100.

Referring to FIG. 11, another aspect of determining a reward will be further described. FIG. 11 is a diagram showing a relationship between time and reward (evaluation point). FIG. 11 shows that there is a plurality of types of rewards, and the difference in each reward is shown as a difference in the slope of the graph shown in FIG. 11. In certain aspects, the reward is defined as standard, greater than standard, less than standard, no reward, special addition. Whether the reward is more or less than the standard is defined as a slope greater than the slope for the standard (=greater than the standard) and a slope less than the slope for the standard (=less than the standard).

In the example of FIG. 11, the effect of the advertisement is zero from the timing t(0) to the timing t(1), and the effect starts to appear from the timing t(1). The graph from timing t(1) to t(2) shows a first reward. The graph from timing t(2) to t(3) shows a second reward. The second reward has an additional amount greater than the first reward. Timing t (4) indicates a third reward. The third reward indicates a special addition. The graph from timing t(4) to t(5) shows a fourth reward.

The timing t(3) to t(4) and the timing t(5) to t(6) indicate that no reward is generated (slope=0).

At timing t(4), when access to the detailed information of the advertisement is detected in the server 170, the remuneration is greatly added on the assumption that the effect of the advertisement is remarkably increased. Thereafter, the effect gradually increases from timing t (4) to timing t (5), and from timing t(5) to timing t(6), the effect of the advertisement is not further increased, and therefore, no additional reward is generated.

The server 170 senses an action that leads to an increase in the effectiveness of the advertisement and transmits the sensed result to the computer 110 of the moving object 100. The evaluation unit 112 adds evaluation points defined in advance for the access. In this manner, the effect corresponding to the user's action on the advertisement can be finely set.

### Third Embodiment

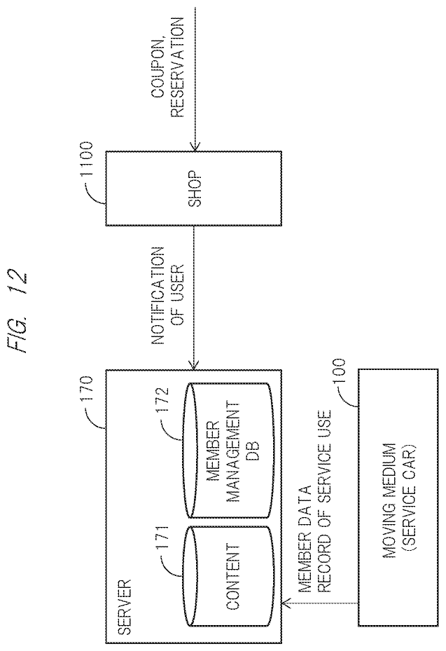

A third embodiment will be described with reference to FIG. 12. FIG. 12 is a diagram showing an outline of a configuration of a system according to the third embodiment. The present embodiment differs from the above-described embodiment in that a reward for an advertisement effect generated after using a service of riding the moving object 100 can be received. The system according to the present embodiment can be realized by the moving object 100 and the server 170 constituting the system according to the above-described embodiment. Therefore, a detailed description of the configuration of the system will not be repeated.

More specifically, when the user of the moving object 100 registers the account of the user as member information at the time of use of the service, for example, at the time of riding, the reward generated after the use of the service can be returned as a point. The registered member information is sent to the server 170 via the network together with service usage records such as usage time, route, and destination. The server 170 manages the received information. When the user uses the discount coupon by using the information transmitted from the moving object 100 or makes a reservation for goods or services by the business operator providing the advertisement, the computer of the shop operated by the business operator transmits a notification to the server 170 that the user actually made a reservation for goods or services. The server 170 also manages points as part of the member information, and adds points to the member's account according to the notification from the store. The member can also use the accumulated points next time or later for a part of the usage fee of the moving object 100 and other services.

The service usage period is limited in time and may not be reflected in the reward even if the advertisement works effectively, especially in the case of short-time usage. Even in such a case, according to the present embodiment, since it is possible to eliminate the difference between the service use time and the occurrence of the advertisement effect, the convenience for the user of the system can be improved.

### Fourth Embodiment

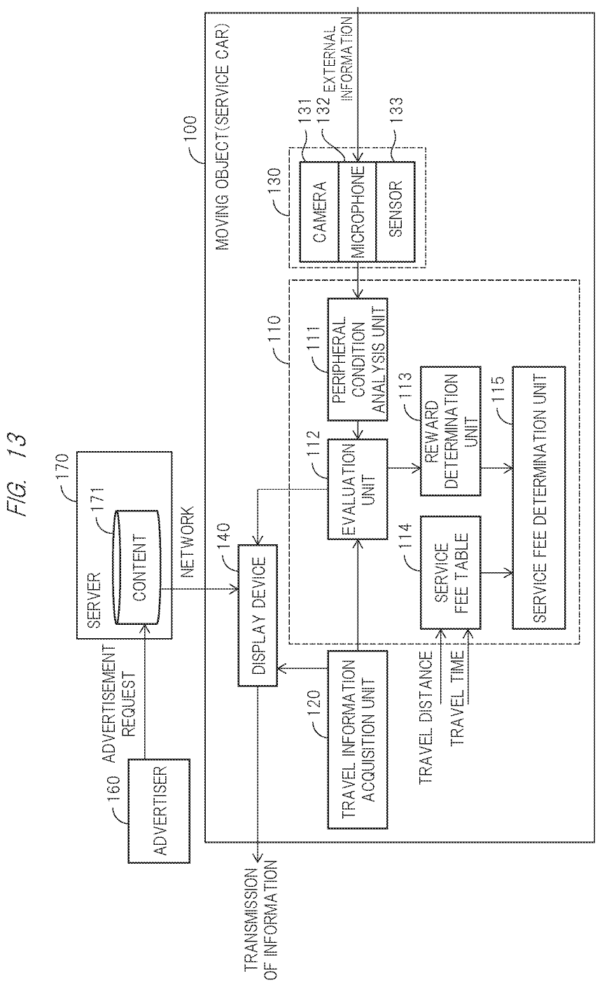

A fourth embodiment will be described with reference to FIG. 13. FIG. 13 is a block diagram showing the configuration of the system according to the fourth embodiment. The moving object 100 according to the present embodiment is different from the above-described embodiment in that the travel information acquired by the travel information acquisition unit 120 is input to the display device 140, and the display device 140 realizes display according to the travel information.

The moving object 100 can change the display method of the advertisement between the case of moving at high speed and the case of moving at low speed or in a stopped state. For example, when the moving object 100 is stopped or moving at a low speed, even if a display device outside the moving object 100 transmits detailed information, there is a possibility that the information may be read by a surrounding passer or the like. However, when the moving object 100 is moving at high speed, the pedestrian cannot read the information displayed outside the moving object 100. Therefore, when the moving object 100 is moving at a high speed, the moving object 100 switches the content displayed on the external display device 140 from the content displayed at the time of moving at a low speed to the content easy to understand such as a video. Thus, when the pedestrian sees the moving object 100 moving at a relatively high speed, the pedestrian can acquire advertisement information by shooting contents such as video. Then, when the pedestrian needs more detailed information, the pedestrian can access the site providing the content via an application installed in the smartphone 600, a Web page, or the like with the relatively readable vehicle body number and position information, and acquire the information.

More specifically, the display device 140 switches the contents to be displayed based on the vehicle speed sent from the travel information acquisition unit 120. This switching is performed based on, for example, whether or not the traveling speed is equal to or higher than a predetermined vehicle speed. As an example, when the vehicle speed for switching is set to 30 km/h, the display device 140 displays relatively detailed information as an advertisement until the stopped moving object 100 starts moving and reaches 30 km/h. Thereafter, when the vehicle speed of the moving object 100 exceeds 30 km/h, the display device 140 displays an advertisement having good visibility and a small amount of information. For example, the display device 140 displays a QR code, a logo, or the like of a sponsor of an advertisement that has been displayed when traveling at a speed of 30 km or less per hour. When the pedestrian is interested in an advertisement displayed outside the moving object 100, the pedestrian can easily access the Web site of the sponsor by photographing a QR code, a logo, or the like.

In this manner, according to the present embodiment, since the advertisement displayed is switched according to the traveling speed of the moving object 100, more efficient advertisement (information transmission) becomes possible.

### Fifth Embodiment

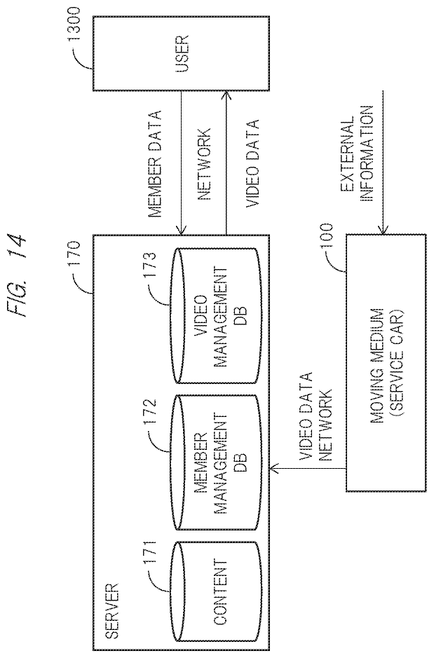

A fifth embodiment will be described with reference to FIG. 14. FIG. 14 is a diagram showing an outline of the system according to the fifth embodiment. The camera 131 included in the moving object 100 can capture an image of the periphery of the moving object 100. The captured image is transmitted from the moving object 100 to the server 170. The server 170 manages the video received from each moving object 100 as a content video. The user 1300 of the service by the moving object 100 can access the server 170 via the Internet, and can refer to or download the video during the service use period (i.e., while riding on the moving object 100).

More specifically, the server 170 according to the present embodiment includes a member management DB 172 and a video management DB 173 in addition to the contents 171. The member managing DB 172 manages member data of services (e.g., car sharing, rental car, use of taxis, etc.) by the moving object 100. The member information may include a user ID of the user 1300, a payment account, a usage history, points, etc. The video management DB 173 manages the video data transmitted from the moving media 100. More specifically, the video management DB 173 includes an identification ID of the video data, an identification ID of the moving object 100 that acquired the video data, a date and time registered in the video management DB 173, a history of accesses to the video data, and the like. The access history includes the user ID of the user who performed the access and the access date and time.

In another aspect, a business company providing services via the moving object 100 can utilize these video data. For example, the video data may be utilized by a broadcaster, police, etc. as a critical instant of an accident, as an evidence image of a crime scene, or as a happening image. In the case where the video data is used in this manner to obtain a consideration, the business company may return a part of the consideration as a point to the user of the moving object 100. In this manner, the fee paid by the user is substantially reduced.

As described above, according to the present embodiment, a secondary service of providing an image shot taken during travel of the moving object 100 is provided, so that the value of traveling the moving object 100 can be increased.

### Sixth Embodiment

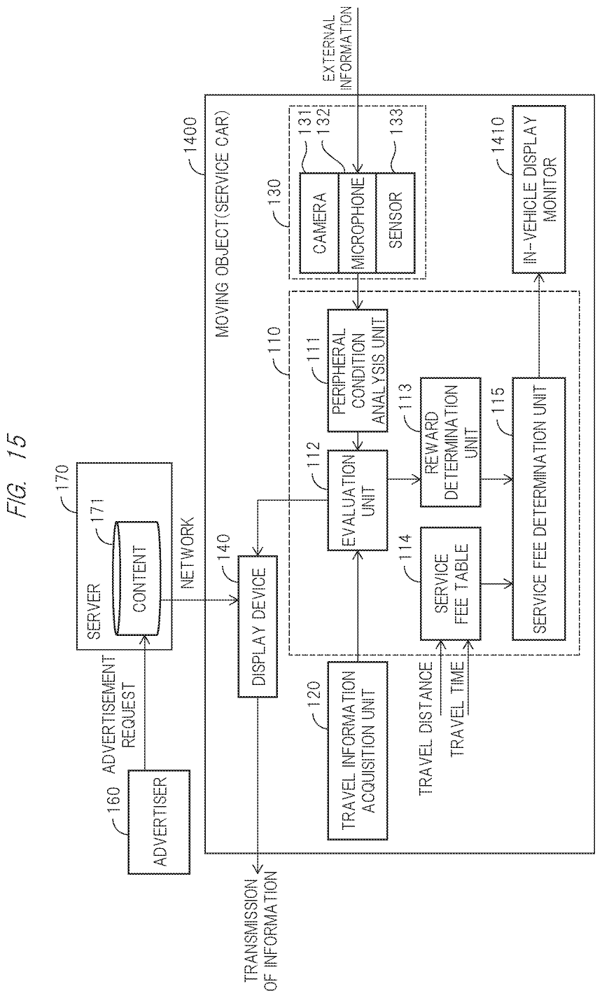

A sixth embodiment will be described with reference to FIG. 15. FIG. 15 is a diagram showing an outline of a configuration of a system according to the sixth embodiment. The moving object 1400 according to the present embodiment further includes an in-vehicle display monitor 1410 in addition to the configuration of the moving object 100. Other configurations are the same as those described above. Therefore, description of other configurations will not be repeated.

The in-vehicle display monitor 1410 is visually recognized by a user of the moving object 100, for example, a passenger who uses an automatic driving service. The in-vehicle display monitor 1410 may be implemented as a head-up display in addition to a display device such as a liquid crystal monitor or an organic EL monitor. The service fee determined by the service fee determination unit 115 is displayed on the in-vehicle display monitor 1410.

According to the present embodiment, the in-vehicle display monitor 1410 can display, in real time, the service usage fee determined according to the travel distance and the travel time, or the service usage fee determined in advance, as well as the fee generated by the advertisement and the final service fee obtained by subtracting the amount of the fee. Therefore, since the user can easily check the fee, troubles such as unjust billing can be prevented.

The disclosed technical features can be summarized as follows.

### First Configuration

According to an aspect, a method performed in a computer (110, 170, 200) includes the steps of: displaying an advertisement on a display device 140 disposed outside the moving object 100; acquiring external information (e.g., the presence or absence of a person watching the moving object 100, the number of persons, etc.) representing the periphery of the moving object 100 based on a signal output from an external information acquisition device (e.g., the external information acquisition unit 130) provided in the moving object 100; acquiring travel information (e.g., speed, travel location, destination, etc.) of the moving object 100; estimating an effect of the advertisement based on the external information and the travel information; and determining a reward for the advertisement based on a predetermined reward criterion and effect.

### Second Configuration

In one aspect, in addition to the above-described configuration, the external information acquisition apparatus includes at least one of a camera 131 for capturing an image of the periphery of the moving object 100 and outputting an image signal, a microphone 132 for capturing sound of the periphery of the moving object 100 and outputting a signal, and a sensor 133 for detecting a proximity state to the periphery of the moving object 100.

### Third Configuration

In one aspects, in addition to the above configuration, the external information includes at least one of the number of viewers of the advertisement, the attributes of the viewer, the response of the viewer to the advertisement, and the distance from the advertisement to the viewer. The travel information includes at least one of the travel speed of the moving object 100 and the position information of the moving object 100. The estimating includes estimating an effect based on the item of external information, the item of travel information, and a predetermined evaluation criterion.

### Fourth Configuration

The method according to one aspect further includes performing a process of reducing the usage fee of the moving object 100 in accordance with the effectiveness of the advertisement, in addition to the above configuration.

### Fifth Configuration

The method according to one aspect further includes, in addition to the above-described configuration, receiving a viewing information based on the viewing of the displayed advertisement from an information communication terminal (e.g., a smartphone) used by a passenger viewing the advertisement of the moving object 100. The estimating includes estimating an effect based on the external information, the travel information, and the viewing information.

### Sixth Configuration

A method according to one aspect further includes, in addition to the above configuration, storing a user identification information of the moving object 100 and the status of use of the goods or services advertised by the advertisement. The determining includes determining a reward according to the use of the goods or services after the use of the moving object 100.

### Seventh Configuration

In one aspect, in addition to the above-described configuration, the acquiring the travel information includes receiving a travel speed of the moving object 100. The displaying the advertisement includes changing a display mode of the advertisement according to the moving speed of the moving object 100.

### Eighth Configuration

In one aspect, in addition to the above-described configuration, the acquiring the external information includes receiving an image signal by taking pictures of the periphery of the moving object 100. The method further includes storing the video signal, providing the video signal based on a request to the computer, and providing a compensation data corresponding to the usage status of the provided video signal to the user of the moving object 100.

### Ninth Configuration

The method according to one aspect further includes computing a discount based on the effect of the advertisement, computing a billing amount for the user of the moving object 100 based on the user fee and the discount amount of the moving object 100, and displaying the billing amount in the moving object 100, in addition to the above configuration.

### Tenth Configuration

According to another aspect, a program for controlling a moving object 100 is provided. The program causes the moving object 100 to perform the steps of: displaying an advertisement on a display device 140 disposed outside the moving object 100; acquiring external information representing the periphery of the moving object 100 based on a signal output from an external information acquisition device (e.g., an external information acquisition unit 130) disposed in the moving object 100; acquiring travel information of the moving object 100 from the moving object 100; estimating an effect of the advertisement based on external information and travel information; and determining the remuneration for the advertisement based on predetermined remuneration standards and the effect.

Although the invention made by the present inventor has been specifically described based on the embodiment, the present invention is not limited to the above embodiment, and it is needless to say that various modifications can be made without departing from the gist thereof.

What is claimed is:

1. A method of evaluating an effect of an advertisement comprising:
displaying the advertisement outside a moving object;
acquiring external information representing a periphery of the moving object based on a signal output from an external information acquisition device provided in the moving object;
estimating the effect of the advertisement based on the external information; and
determining a reward for the advertisement based on a predetermined reward criterion and the effect of the advertisement.

2. The method according to claim 1, wherein the method further comprising acquiring travel information of the moving object from the moving object.

3. The method according to claim 2, wherein the external information acquisition device includes at least one of a camera for photographing the periphery of the moving object, a microphone for acquiring sound around the moving object, and a proximity sensor for detecting proximity to the periphery of the moving object.

4. The method according to claim 2,
wherein the external information includes at least one of a number of viewers of the advertisement, an attribute of each viewer, a response by each viewer to the advertisement, and a distance from the advertisement to each viewer,
wherein the travel information includes at least one of a travel speed of the moving object and a positional information of the moving medium, and
wherein the estimating includes estimating the effect based on the external information, the travel information, and a predetermined evaluation criterion.

5. The method according to claim 2, further comprising a performing a process of reducing a usage fee of the moving object in response to the effect of the advertisement.

6. The method according to claim 2, further comprising receiving viewing information based on viewing of the displayed advertisement,
wherein the estimating comprises estimating the effect based on the external information, the travel information, and the viewing information.

7. The method according to claim 2, further comprising storing an identification information of a user of the moving object and utilization of goods or services advertised by the advertisement,
wherein the determining comprises determining a reward for utilization of the goods or services after utilization of the moving object.

8. The method according to claim 2,
wherein the acquiring travel information includes receiving a moving speed of the moving object, and
wherein the displaying includes changing a display mode of the advertisement according to the moving speed of the moving object.

9. The method according to claim 2,
wherein the acquiring external information includes receiving a video signal by photographing the periphery of the moving object, and
wherein the method further includes:
accumulating the video signal;
providing a video signal based on a request to a computer; and
providing a compensation data to a user of the moving object according to a usage state of the provided video signal.

10. A program for processing information, the program causing a computer to execute:
displaying an advertisement outside a moving object;
acquiring external information representing the periphery of the moving object based on a signal output from an external information acquisition device provided in the moving object;
acquiring travel information of the moving object from the moving object;
estimating an effect by the advertisement based on the external information and the travel information; and
determining a reward for the advertisement based on a predetermined reward criterion and the effect.

11. The program according to claim 10, wherein the external information acquisition device includes at least one of a camera for photographing the periphery of the moving object, a microphone for acquiring sound of the periphery of the moving object, and a proximity sensor for detecting proximity to the periphery of the moving object.

12. The program according to claim 10,
wherein the external information includes at least one of a number of viewers of the advertisement, an attribute of each viewer, a response by each viewer to the advertisement, and a distance from the advertisement to each viewer,
wherein the travel information includes at least one of a travel speed of the moving object and a positional information of the moving object, and
wherein the estimating includes estimating the effect based on the external information, the travel information, and a predetermined evaluation criterion.

13. The program according to claim 10, further causes the moving object to perform processing to reduce a usage fee of the moving object in response to the effect of the advertisement.

14. The program according to claim 10, further comprising receiving viewing information based on viewing of the displayed advertisement,
wherein the estimating comprises estimating the effect based on the external information, the travel information, and the viewing information.

15. The program according to claim 10,
wherein the program causes the moving object to further perform storing identification information of a user of the moving object and usage status of goods or services advertised by the advertisement,
wherein the determining comprising determining a reward according to usage of the goods or services after usage of the moving object.

16. The program according to claim 10,
wherein the acquiring travel information includes receiving a moving speed of the moving object, and
wherein the displaying includes changing a display mode of the advertisement according to the moving speed of the moving object.

17. The program according to claim 10,
wherein the acquiring includes receiving a video signal by photographing the periphery of the moving object, and
wherein the program further causes the computer to execute:
accumulating the video signal in the moving object,
providing the video signal based on a request for the moving object, and
providing a compensation data corresponding to a usage state of the provided video signal to a user of the moving object.

18. The program according to claim 10, wherein the program further causes the moving object to perform steps of:
calculating a discount amount based on the effect of the advertisement;
calculating a bill amount for a user of the moving object based on a usage fee of the moving object and the discount amount; and
displaying the bill amount on the mobile object.

19. A moving object comprising:
a display device;
a sensor for obtaining external information representing a periphery of the moving object; and
a processor connected to the display device and the sensor,
wherein the processor is configured to display an advertisement on the display device, obtain travel information of the moving object from the moving object, estimate an effect due to the advertisement based on the external information and the travel information, and determine a reward for the advertisement based on a predetermined reward criterion and the effect.

20. The moving object according to claim 19,
wherein the external information includes at least one of a number of viewers of the advertisement, an attribute of each viewer, a response by each viewer to the advertisement, and a distance from the advertisement to each viewer,
wherein the travel information includes at least one of a travel speed of the moving object and positional information of the moving object, and
wherein the moving object estimates the effect based on the external information, the travel information, and a predetermined evaluation criterion.
